(19) United States
(12) Patent Application Publication
(10) Pub. No.: US 2025/0368494 A1
(43) Pub. Date: Dec. 4, 2025

(54) KEG COUPLER WITH CLEANING VALVE

(71) Applicant: Taphandles LLC, Seattle, WA (US)

(72) Inventors: Paul Fichter, Austin, TX (US); Randall Scott Toy, Sammamish, WA (US); David Carter, Tiverton (GB)

(21) Appl. No.: 19/248,802

(22) Filed: Jun. 25, 2025

(30) Foreign Application Priority Data
Feb. 26, 2024 (GB) 2409199.3
Feb. 14, 2025 (GB) 2502245.0

(51) Int. Cl. B67D 1/08

(52) U.S. Cl. CPC B67D 1/0834

(57) ABSTRACT

A coupler for a beverage keg has a coupler body, a first inlet for connection to the beverage keg, a second inlet for receiving compressed gas, a gas outlet adjacent the first inlet, a cleaning fluid port for connection with a flow of cleaning fluid, and a beverage port for fluid connection with a beverage dispenser. A valve has first and second valve members. The first valve member is axially movable within the coupler body between a first position in which a fluid flowpath between the second inlet and the gas outlet is closed and a second position in which a fluid flowpath between the second inlet and the gas outlet is open. The second valve member is axially movable within the first valve member between a cleaning position in which a fluid flowpath between the cleaning fluid port and the beverage port is open and a flowpath between the first inlet and the beverage port is closed, and a dispensing position in which the fluid flowpath between the cleaning fluid port and the beverage port is closed and the flowpath between the first inlet and the beverage port is open.

### TECHNICAL FIELD

The present disclosure relates to a coupler for a beverage keg, in particular to a coupler having an integrated cleaning valve to allow for cleaning of the coupler in situ.

### BACKGROUND

It is known to provide couplers for connecting beverage lines to a beverage keg, e.g. a traditional beer keg, to enable the beverage product to be dispensed via the beverage lines. Typically the keg will contain a spear type dispensing valve which draws beverage product from the bottom of the keg to a keg valve. Inert gas, for example carbon dioxide, nitrogen, or a combination of such gasses are supplied into the upper part of the keg via an outer concentric valve of the keg valve to pressurise the fluid therein such that when an inner concentric valve of the keg valve is opened the gas pressure forces the beverage up the spear and out of the keg valve.

Keg couplers, as known in the art, typically have a valve that when actuated provides a flow of gas into the keg via the outer concentric valve and opens the inner concentric valve to allow beverage to flow out of the keg valve and into the beverage line via the keg coupler.

In order to maintain the keg coupler in a sanitary condition it is necessary to clean it, and also to clean the beverage dispense lines. Often, to fully clean the couplers inside it is necessary to dismantle them.

Some attempts have been made to integrate cleaning supply into the keg coupler, however due to various shortcomings these have been commercially unsuccessful. An example of such a coupler is disclosed in DE4312516.

In the advent of a greater demand for low and non-alcoholic and beverages the requirement for good sanitation is increased. Previously the alcohol content of many draft beverages such as beer was sufficient to prevent many bacteria from growing. However with low or no alcohol content bacteria is able to grow more easily and more frequent and complete cleaning is necessitated.

It is an aim of the present invention to address one or more of the disadvantages associated with the prior art.

### SUMMARY OF THE INVENTION

Aspects and embodiments of the invention provide a coupler as claimed in the appended claims.

According to an aspect of the present invention there is provided a coupler for a beverage keg the coupler comprising: a coupler body; a first inlet for connection to a beverage keg via a coupling means; a second inlet for receiving a supply of compressed gas; a gas outlet adjacent the first inlet; a cleaning fluid port for fluid connection with a flow of cleaning fluid; a beverage port for fluid connection with a beverage dispenser; and valve means. The valve means comprises: a first valve member axially movable within the coupler body between a first position in which a fluid flowpath between the second inlet and the gas outlet is closed and a second position in which a fluid flowpath between the second inlet and the gas outlet is open; and wherein, a second valve member axially movable within the first valve member between a cleaning position in which a fluid flowpath between the cleaning fluid port and the beverage port is open and a flowpath between the first inlet and the beverage port is closed, and a dispensing position in which the fluid flowpath between the cleaning fluid port and the beverage port is closed and the flowpath between the first inlet and the beverage port is open.

The second valve member may have a valve plug at a distil end thereof, the valve plug sealing against a valve seat disposed on the first valve member when the second valve member is in the first position and spaced away from the valve seat when the second valve member is in the second position. In this manner the valve plug sealingly closes the end of the first vale member when the first second valve member is in the cleaning position. This enables the coupler to be internally cleaned both when it is coupled to a keg, and when it is not.

A cleaning chamber may be created between the first valve member, the second valve member and the valve plug when the second valve member is in the cleaning position. Optionally a cleaning fluid flow passage can extend axially along the keg coupler from the cleaning fluid inlet between the first valve member and the second valve member. The cleaning fluid flow passage may extend between the cleaning fluid inlet and the cleaning chamber. In this manner the cleaning fluid path through the coupler passes along the full internal length of the coupler thereby ensuring that there are no areas that are not cleaned by a through flow of cleaning fluid.

A cleaning valve is optionally formed between the exterior of the second valve member and the interior of the first valve member, said cleaning valve actuated by relative axial movement of the second valve member within the first valve member, said valve operable to selectively open and close the cleaning fluid flow passage. The coupler may be configured such that when the second valve member is in the cleaning position the cleaning valve is open to permit cleaning fluid flow between the cleaning fluid inlet and the cleaning chamber and optionally such that when the second valve member is in the dispensing position the cleaning valve is closed to prevent cleaning fluid flow between the cleaning fluid inlet and the cleaning chamber.

The second valve member preferably comprises a substantially hollow member having the beverage port at one end and the valve plug at the other end, and may comprise an internal flowpath between a second valve member opening adjacent the valve plug and the beverage port.

The second valve member opening can be located between the valve plug and the cleaning valve such that, when the second valve member is in the cleaning position the second valve member opening is located on the cleaning chamber. In this way cleaning fluid necessarily flows through the cleaning chamber, all the way to the valve plug.

A section of the second valve member is preferably located concentrically within the first valve member.

In an embodiment, the first valve member is movable by a first actuator coupled to the connector body and the second member is movable by a second actuator coupled to the first valve member. The first actuator may comprise a latch mechanism for latching the first valve member in the first position or the second position and the second actuator comprises a latch mechanism for latching the second valve member in the cleaning position or the dispensing position.

In an embodiment the first actuator and/or the second actuator is manually operable and in an alternative embodiment first actuator and/or the second actuator is automatically operable.

The first actuator and/or the second actuator may comprise a manually operated pivoted lever mechanism.

The second actuator may comprise a fluid operated cylinder formed between the first valve member and the second member. The second actuator may include a piston movable within the cylinder. In an embodiment a cylinder body may be formed in the first valve member and the piston may be provided on the second valve member such that application of fluid pressure to one side of the piston or the other causes the second valve member to move between the cleaning position and the dispensing position.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a front view of a coupler of the invention with the first valve member in the first position and the second valve member in the cleaning position.

FIG. 2 shows a side view of FIG. 1;

FIG. 3 shows a front view of the coupler of the invention with the first valve member in the first position and the second valve member in the cleaning position, attached to a spear valve;

FIG. 4 shows a side view of FIG. 3;

FIG. 5 shows a front view of a coupler of the invention attached to a spear valve with the first valve member in the second position and the second valve member in the cleaning position;

FIG. 6 shows a side view of FIG. 5;

FIG. 7 shows a front view of a coupler of the invention attached to a spear valve with the first valve member in the second position and the second valve member in the dispensing position;

FIG. 8 shows a side view of FIG. 7;

FIG. 9 shows a schematic diagram of a system using the couplers of the invention;

FIG. 10 shows a side image of a coupler according to the invention;

FIG. 11 shows a section on “A”-“A” of FIG. 10; and

FIG. 12 shows a section on “B”-“B” of FIG. 11.

### DETAILED DESCRIPTION

A coupler in accordance with an embodiment of the present invention is described herein with reference to the accompanying Figures.

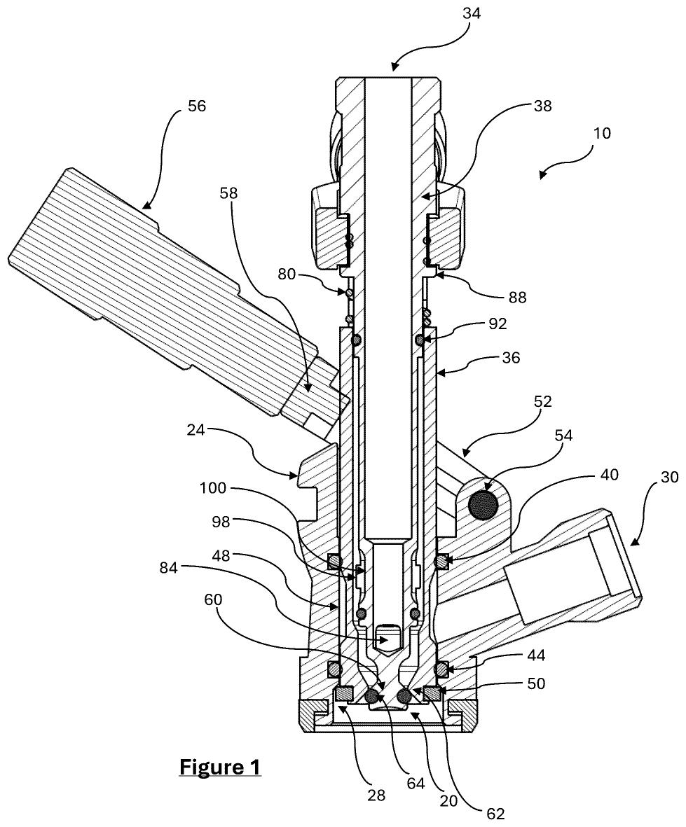

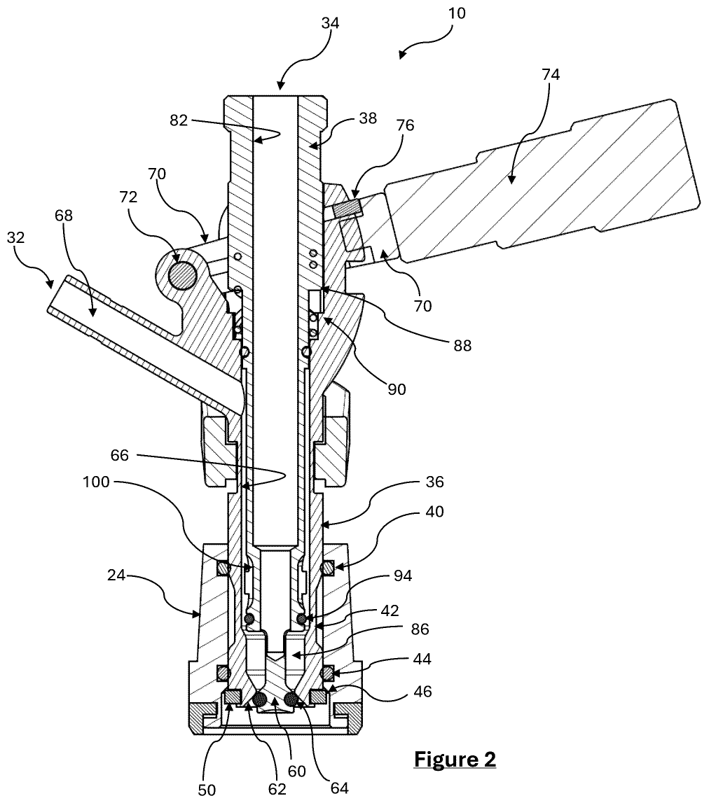

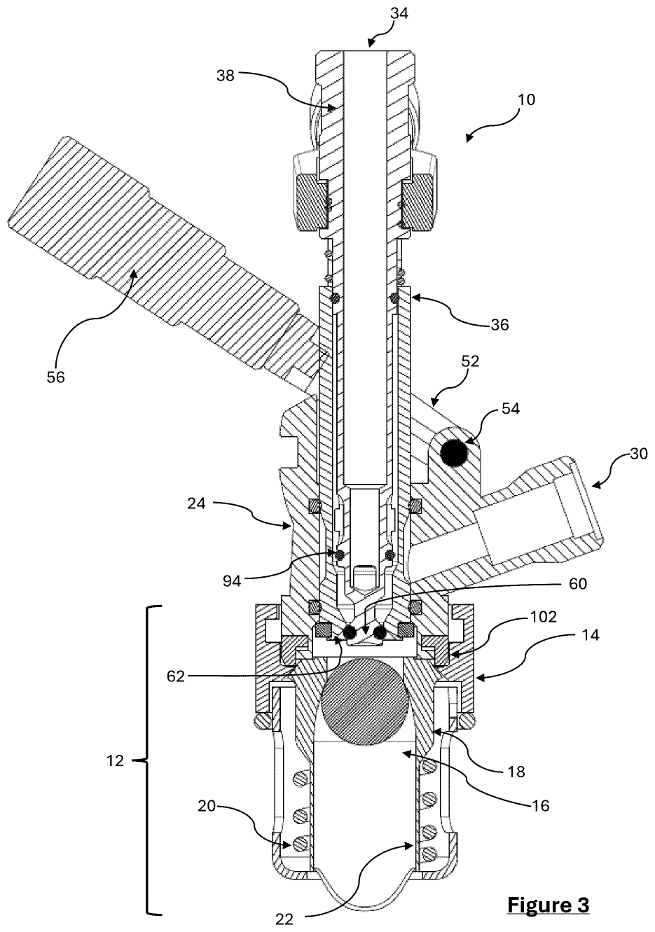

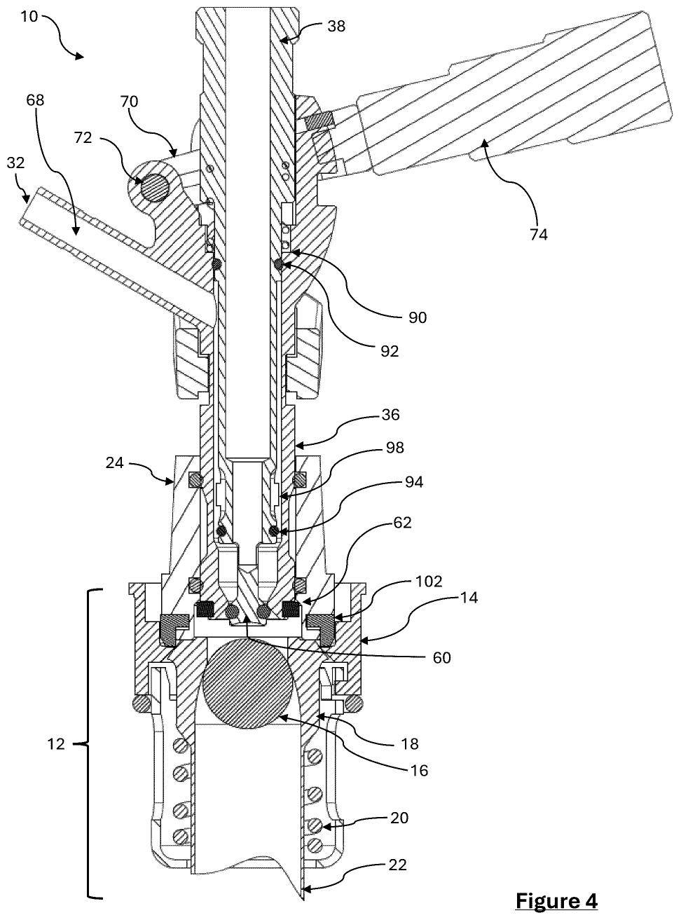

With reference to FIGS. 1 and 2, a coupler 10 for a beverage keg is shown. In FIGS. 3 and 4 the coupler 10 is shown attached to a spear valve 12 of a keg (omitted for clarity), and in. The spear valve 12 is of the type known in the art and comprises a housing that sealingly locates in the top of a beverage keg, for example a beer keg, and an inner 16 and an outer 18 concentric valve member. The outer valve member 18 is displaceable against a spring 20 to open and close a flow path around the spear 22, and the inner valve member 16 is displaceable to open and close a flow path through the spear 20. The spear 20 extends from the spear valve substantially to the bottom of the keg such that liquid is forced up the spear 20 when a gas pressure is applied to the interior of the keg via the outer valve member 18, as will be understood by the skilled person. The coupler 10 has a keg seal 102 thereon which sealingly engages with the spear valve 12.

The coupler has a coupler body 24, a first inlet 26 for connection to a beverage keg via a coupling means as known in the art, for example a D-Type keg coupler (although it will be appreciated the invention may be used with different types of coupler) a second inlet 30 for receiving a supply of compressed gas, and a gas outlet 28 adjacent the first inlet 26. A cleaning fluid port 32 is provided for fluid connection with a flow of cleaning fluid and a beverage port 34 is provided for fluid connection with a beverage dispenser.

Valve means for controlling the selective flow of fluid through the coupler 10 are provided and comprise a first valve member 36 and a second valve member 38. The cleaning fluid port 32 is provided in the first valve member and the beverage port 34 is provided in one end of the second valve member.

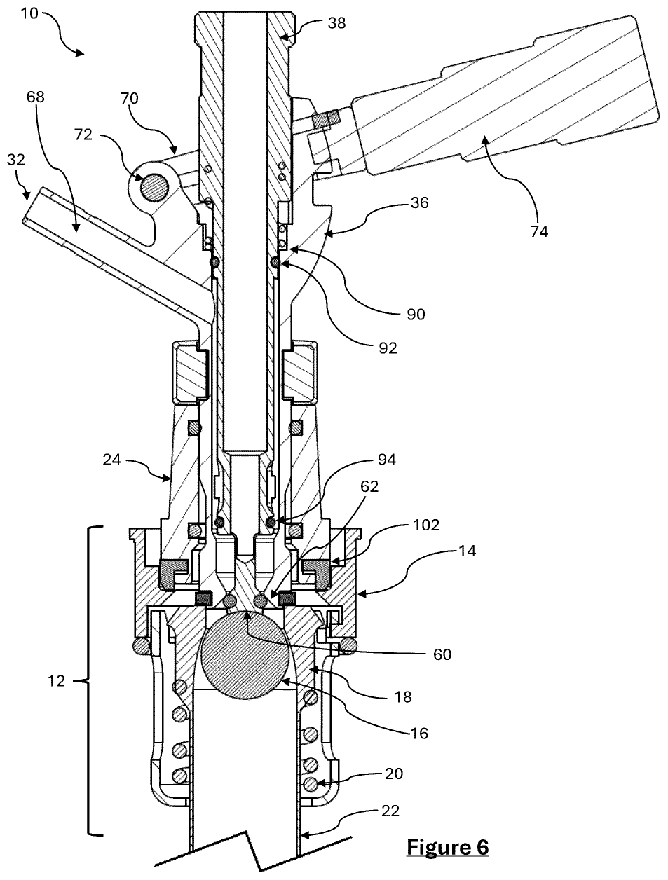

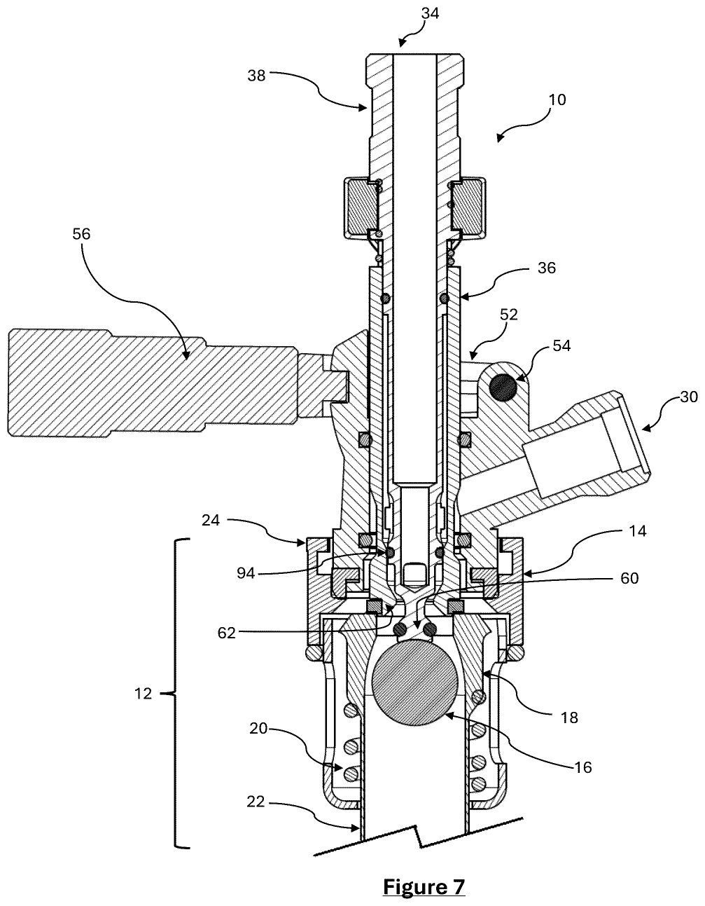

The first valve member 36 is axially movable within the coupler body 24, in particular the first valve member includes a substantially cylindrical section disposed and axially movable within a substantially cylindrical bore 48 within the coupler body 24. A first seal 40, for example a first O-ring, is provided between the substantially cylindrical section and the substantially cylindrical bore to create a seal therebetween to prevent fluid passing between first valve member 36 and the coupler body 24 in a direction away from the gas outlet 28. The first valve member 36 is axially movable between a first position depicted in FIGS. 1 to 6, and a second position depicted in FIGS. 6 and 7.

The first valve member 36 has a recessed portion 42 in the substantially cylindrical section, the gas inlet 30 opening into the cylindrical bore of the coupler body 24 at a position with at least partially overlapping with the recessed portion 42 such that gas from supplied to the gas inlet 30 enters the recessed portion 42.

A second seal 44, for example a second O-ring, is provided between the substantially cylindrical section and the substantially cylindrical bore to create a seal therebetween at a position between the first seal 40 and the gas outlet 28. When the first valve member 36 is in the first position as depicted in FIGS. 1 to 4, the recessed portion 40 is positioned between the first seal 40 and the second seal 44 such that gas supplied to the second inlet 30 is trapped in the recessed portion 42 by the first and second seals 40, 44.

The valve body 24 is provided with a gas outlet seat 46 at the gas outlet 28, the gas outlet seat 46 having the form of an inwardly chamfered edge leading into the substantially cylindrical bore 48 within the coupler body 24. The first valve member 36 is provided with a valve seal 50 on the exterior of its end adjacent the gas outlet seat 46. When the first valve member 36 is in the first position the valve seal 50 seals against the gas outlet seat 46 and acts as an additional seal to prevent gas from the recessed portion 42 from exiting the gas outlet 28. In this manner, when the first valve member 36 is in the first position a fluid flow path between the second inlet 30 and the gas outlet 28 is closed.

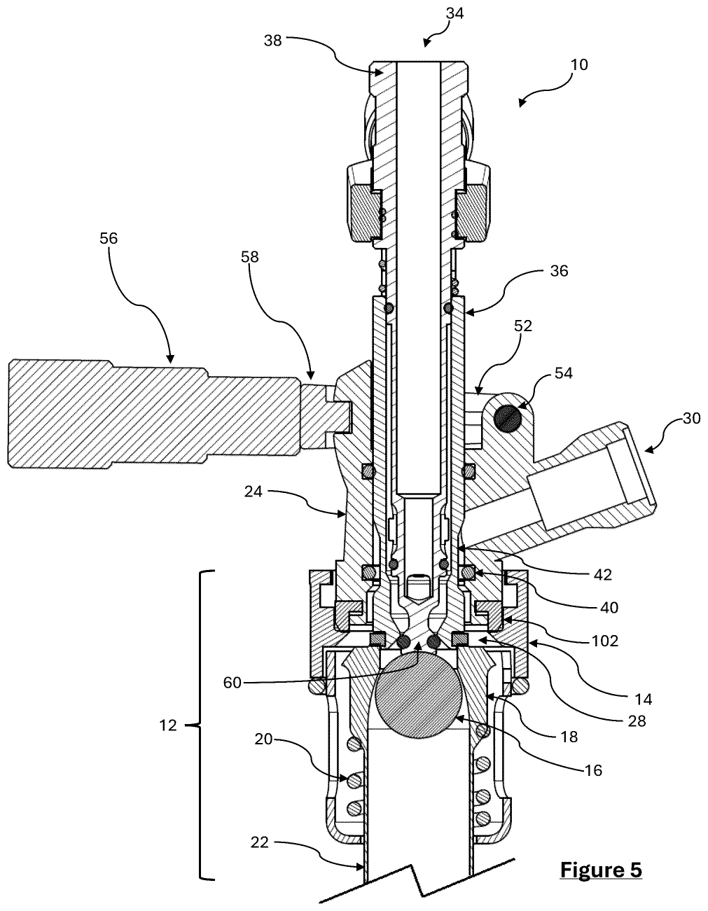

When the first valve member 36 is axially moved into the second position, as depicted in FIGS. 5 to 8, the recessed portion 42 moves such that it bridges the second seal 44 thereby bypassing the second seal 44, and the valve seal 50 moves axially away from the gas outlet seat 46. In this manner, in the second position an open fluid flowpath is created between the second inlet 30 and the gas outlet 27, via the recessed portion 42.

A first actuator 52 is pivotally attached to the coupler body 24 via a pivot pin 54 on a first side of the coupler 10 and extends past the first valve member 36, with which it is coupled via a sliding mechanism, to the opposite side of the coupler 10, where it terminates in an actuator handle 56. The handle 56 is pivotally movable relative to the coupler body 24 to slide the first valve member 36 therein. When the actuator handle 56 is in a raised upper position, as depicted in FIGS. 1 to 4, the first valve member is in the first position and when the actuator handle 56 is in a lowered position, as depicted in FIGS. 5 to 8, the first valve member is in the second position. The first actuator 52 includes a latch mechanism 58 for latching the first valve member 36 in the second. Although not depicted in the example embodiment the latch member 58 can also be arranged to latch the first valve member 36 in the first position. The latch member 58 can be sprung towards the connector body 24 such that in the lowered position it is biased into the a latched position, and may be released by urging it away from the latched position for example by manually pulling the handle 56 outward and away from the pivot pin 54.

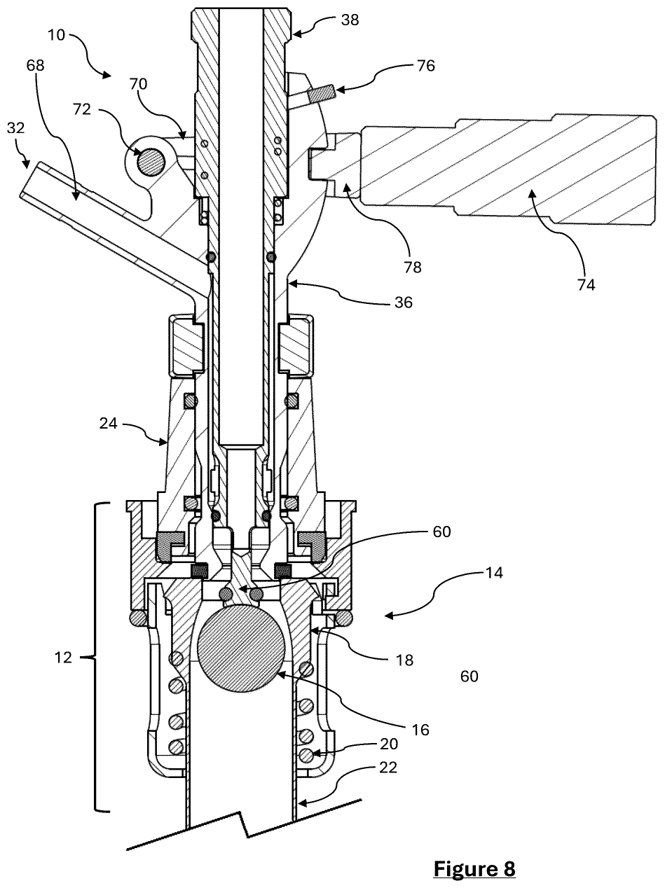

As can be seen in FIGS. 7 to 8, when the first valve member 36 is in the second position it the valve seal 50 thereon engages with the outer valve member 18 of the spear valve 12 to seal thereagainst around the inner valve member 16, and displaces the outer valve member 18 downward. This enables gas to flow from the second inlet 30 out of the gas outlet of the coupler, past the outer valve member of the spear valve and into the beverage keg. The gas pressurises the beverage in the keg to urge it up the spear towards the inner valve member 16. However, as the inner valve member has not been acted on by the first valve member 36 of the coupler 10, beverage is prevented from exiting the spear valve.

The second valve member 38 is located such that section thereof extends concentrically through the first valve member 36, and is axially movable in the first valve member 36 between a cleaning position depicted in FIGS. 1 to 6, in which a fluid flowpath between the cleaning fluid port 32 and the beverage port 34 is open and a flowpath between the first inlet 26 and the beverage port 34 is closed, and a dispensing position in which the fluid flowpath between the cleaning fluid port 32 and the beverage port 34 is closed and the flowpath between the first inlet 26 and the beverage port 34 is open. In this manner, when fluid is passed through the coupler 10 it is prevented from exiting the coupler 10 via the first inlet 26. This means that the coupler can be cleaned internally, even when disconnected from a keg by simply passing a flow of cleaning fluid between the cleaning fluid inlet 32 and the beverage port 34.

The second valve member 38 has a valve plug 60 at a distil end thereof, i.e. the end that is away from the beverage port 34. When the second valve member 38 is jn the cleaning position, the valve plug 60 seals against a valve seat 62 which is disposed on the end of the first valve member 36 away from the cleaning fluid inlet 32. The valve plug 60 maybe provided with a resilient seal 64 thereon, for example an O-ring located within a recess in the valve plug 60, to seal against the valve seat 62. It will be appreciated that a resilient seal may alternatively be provided on the valve seat 62, or could be omitted. The valve seat 62 is located concentrically within the valve seal 50 and comprises an inwardly tapering surface leading into a bore 66 extending through the first valve member 36, i.e. the first valve member 38 is substantially hollow. The second valve member 38 extends through the bore 66 and is movable axially therein from the cleaning position in which the valve plug 60 seals against the valve seat 62, and a dispensing position in which the valve plug 60 is spaced away from the valve seat 62. A passage 68 leads from the cleaning fluid inlet 32 through the first valve member 36 and opens into the bore 66.

A second actuator 70 is pivotally attached to the first valve member 36 via a pivot pin 72 on a first side of the first valve member 36 and extends past the second valve member 38, with which it is coupled via a sliding mechanism, to the opposite side of the first valve member 36, where it terminates in an second actuator handle 74. The second actuator handle 74 is pivotally movable relative to the first valve member 36 to slide the second valve member 38 therein. When the second actuator handle 74 is in a raised upper position, as depicted in FIGS. 1 to 6, the second valve member 38 is in the cleaning position and when the second actuator handle 74 is in a lowered upper position, as depicted in FIGS. 7 and 8, the second valve member 38 is in the dispensing position. The second actuator 70 includes a latch mechanism 76 for latching the second valve member 38 in the cleaning position and a latch member 78 for latching the second valve member 38 in the dispensing position. The latch members 78 can be sprung towards the first valve member 36 such that in the lowered position it is biased into the latched position, and may be released by urging it away from the latched position for example by manually pulling the handle 74 outward and away from the pivot pin 72. Other latch types known in the art may be used. A spring 80 may be provided between the first valve member 36 and the second valve member 38, for example adjacent to the actuator 70, to bias the second member into the cleaning position.

The bore 66 through the first valve member 36 has a first section having a first bore diameter into which the passage 68 opens, the first bore diameter extending down a substantial part of the bore 66. At the end towards the valve seat 62 the bore diameter decreases to a second bore diameter for a short section and from there tapers inwardly to the valve seat 62.

The second valve member 38 has a bore 82 extending therealong from the beverage port 34 to openings 84 therein, the openings 84 being located in the second valve member 38 adjacent to the valve plug 60 such that an internal flowpath is formed through the second valve member 38 from the beverage port 34 to the outlets 84.

From the openings 84 to the valve plug 60, the cross section of the second valve member 38 is reduced such that a cleaning chamber 86 defined by an enclosed area is created between the first valve member 36, the second valve member 38 and the valve plug 60 when the second valve member is in the cleaning position. The openings 84 are therefore located within the cleaning chamber 86.

The second valve member 38 has an outer diameter that changes along its length. It has a first largest outer diameter at an upper end thereof. This outer diameter reduces to a second intermediate diameter below the second actuator handle 74 forming a step 88 which, when the second valve member 38 is in the dispensing position, abuts shoulder 90 on the first valve member 36 to limit the movement of the second valve member 38. The second intermediate diameter extends into the bore 66 of the first valve member 36 and seals there against. In order to provide a good seal an O-ring seal 92 is provided in a groove in the second valve member 38 to form a sliding seal with the first valve member. The O-ring seal is provided on the second valve member 38 at a location that is within the bore 66 between the step 88 and the point at which the passage 68 opens into the bore 66. Between the O-ring seal 92 and the point at which the passage 68 opens into the bore 66 the diameter of the second valve member 38 reduces to a third diameter such that a gap is formed between the outer surface of the second valve member 38 and the inner surface of the first valve member, i.e. the surface of the bore 66. This gap forms a cleaning fluid flow passage which extends axially along the keg coupler 10 from the cleaning fluid inlet 32 and between the first valve member and the second valve member. The cleaning fluid flow passage extends to the cleaning chamber 86.

The above features mean that with the second valve member 38 in the cleaning position, a flowpath for cleaning fluid is this created from the cleaning fluid inlet 32, through the passage 68, along the gap between the first valve member 36 and the second valve member 38, into the cleaning chamber 86, into the openings 84, up the central bore 82 of the second valve member 38 and to the beverage port 34. As such the entire interior of the coupler 10 from the valve seat 62 to the beverage port 34 through which in use a beverage will pass from the keg to the point of dispense, is cleaned by a flow of cleaning fluid passing thereover. It will be appreciated that as the valve seat 62 sealingly encloses the entire interior volume of the coupler 10, that no check valve is needed to prevent beverage draining back from the beverage line, via the beverage port 34 when the coupler is disconnected from a keg. This has the advantage that cleaning fluid can be passed through the coupler between the cleaning fluid inlet 32 and the beverage port 34 in either direction, enabling bidirectional cleaning.

On the third diameter of the second cleaning member 28 adjacent to the openings 84, a valve seal in the form of an O-ring 94 is provided. When the second valve member is in the cleaning position the O-ring 94 is located in the first section of the bore 66 adjacent the cleaning chamber. At this location the diameter of the bore 66 is greater that the outer diameter of the O-ring 94 such that cleaning fluid can pass around the O-ring 94 to pass between the gap between the first valve member 36 and the second valve member 38, and the cleaning chamber 86. When the second valve member moves into the dispensing position the O-ring 94 moves with the second valve member 38 such that it enters short section of the bore 66 having the decreased diameter. The O-ring 94 is sized such that the outer diameter thereof forms a seal with the bore 66 at the second bore diameter thereby preventing cleaning fluid from passing the O-ring 94. The movement of the O-ring 94 between the first bore diameter and the second bore diameter forms a cleaning valve between the exterior of the second valve member 38 and the interior of the first valve member 36 which is actuated by relative movement of the second valve member 38 within the first valve member 36 to selectively open and close the cleaning fluid flow passage. As such, when the second valve member 38 is in the cleaning position the cleaning valve is open to permit cleaning fluid flow between the cleaning fluid inlet 32 and the cleaning chamber 86 and when the second valve member 38 is in the dispensing position the cleaning valve is closed to prevent cleaning fluid flow between the cleaning fluid inlet 32 and the cleaning chamber 86. The openings 84 are located between the valve plug 60 and the cleaning valve such that, when the second valve member 38 is in the cleaning position the openings 84 are located on the cleaning chamber 86.

As the second valve member 38 extends concentrically within, and spaced from the bore 66 of the first valve member 36, when the second valve member 38 is in the dispensing position it is substantially unsupported along a section of its length through which a dispensed beverage may flow. This can cause vibration within the coupler 10 in use. In order to prevent this, the second valve member 38 is provided with a plurality of fins 98 extending radially therefrom towards its lower end. The outer circumference defined by a circle passing through the outer limit of the fins 98 is substantially the same as the diameter of the first section of the bore 66. The fins 98 are axially located adjacent the O-ring 94 of the cleaning valve at a position that remains within the first section of the bore 66 when the second valve member 38 is in the dispensing position. In this manner, the free end of the second valve member 38 is maintained in a central position within the bore such that as it is closed the seal 64 is centralised on the valve seat 62. In addition, the fins 98 support of the free end of the second valve member may assist in reducing flow induced vibration when the valve is open. A plurality of recesses 100 may be provided in the second valve member 38 between the fins 98 such that the cross-sectional area of the cleaning fluid flow passage formed by the gap between the first valve member 36 and the second valve member 38 is not reduced in the vicinity of the fins 98.

As described herein the first and second actuators are manual actuators, however it will be appreciated other types of actuator, manual or automatic, for example pneumatically or electrically powered actuators may be used.

Referring to FIGS. 5 and 6, it can be seen that the keg coupler of the present invention can assume a position in which the coupler is connected to a keg, and the first valve member 36 is in the second position such that gas pressure is provided to the interior of the keg to which it is connected, but that the when the second valve member 38 is in the cleaning position, the valve seat 60, which as described hereinabove is latched in place, isolates the interior of the coupler through which cleaning fluid can be passed in a cleaning operation, from the inner concentric valve member 16 of the spear valve. This isolation results in improved sanitation and beverage quality as it eliminates the possibility of cleaning fluid pressure acting on the inner concentric valve, which is openable by pressure applied from the direction of the interior of the coupler 10, and potentially entering the barrel and mixing with product therein. It also prevents any bacteria which may be on the exterior surface of the inner concentric valve from being pushed into the barrel.

These advantages are particularly beneficial when dispensing low and non-alcoholic beverages which, due to the low alcohol content need their dispensing equipment to be cleaned more regularly than products having a higher alcohol content. The coupler of the present invention enables the entirety of the product line from the point at which the beverage enters the coupler 10 to be cleaned in situ without the need to remove it from a partially used keg. This enables more effective and efficient regular cleaning.

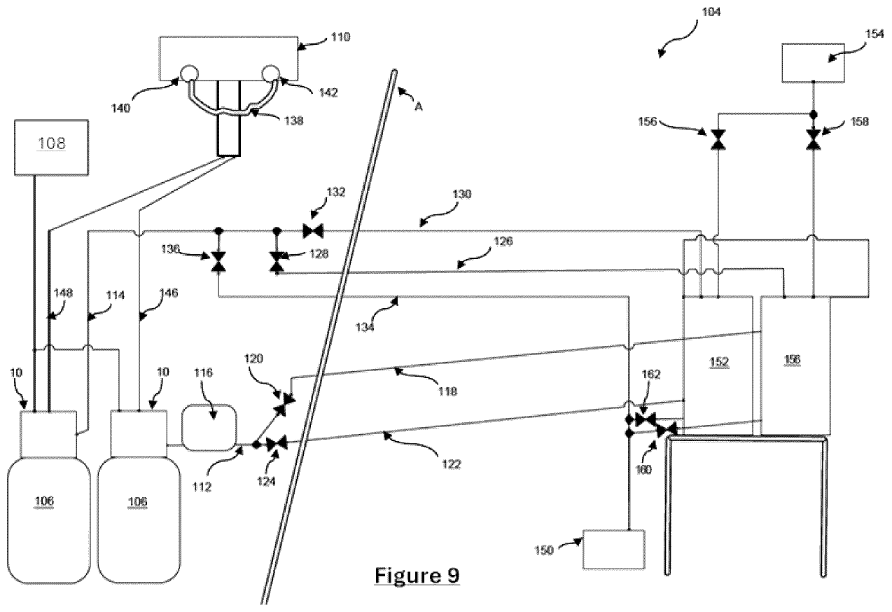

Referring to FIG. 9, a cleaning system 104 using the coupler 10 described herein is shown. The system comprises a number of pressurised kegs 106, two in this case, each having a coupler 10 attached thereto. The couplers 10 are connected to a source of pressurised carbon dioxide 108 via their respective gas inlets 30. The beverage port 34 of each coupler is attached to a beverage dispensing unit 110 from which the beverage can be dispensed as known in the art, e.g. via outlets 140 142 in the form of taps on the beverage dispensing unit 110. To enable beverage dispensing, the coupler 10 is in the position as shown in FIGS. 7 and 8.

A cleaning fluid inlet conduit 112 is attached to the cleaning fluid port 32 of one coupler 10 and a cleaning fluid return conduit 114 is attached to the cleaning fluid port 32 of the other coupler 10. As described above, with the couplers 10 in the position described in FIGS. 7 and 8, flow of cleaning fluid through the couplers 10 is prevented.

The system also includes a pump 116 in the inlet conduit 112. Upstream of the pump 116, the inlet conduit 112 is connected to a water supply conduit 118 via a first inlet valve 120, and to a cleaning fluid supply conduit 122 via a second inlet valve 124, the first and second inlet valves 120, 124 are selectively operable to supply one of water and cleaning fluid to the pump 116.

The cleaning fluid return conduit is connected a rinse recirculation line 126 via a first return valve 128, a cleaning fluid recirculation line 130 via a second return valve 132, and a drain line 134 via a third return valve 136.

When cleaning is required, a cleaning jumper 138 is attached between the outlets 140, 142 of the beverage dispensing unit 110 to create a fluid flow path therebetween. The couplers 10 are then placed in the configuration shown in FIGS. 1 to 4, either by manual or automatic operation of the first and second valve members 36, 38. The flow path between the keg 106 and the beverage port 34 of its respective coupler 10 is therefore closed and the flow path between the cleaning fluid inlet 32 and the beverage port 34 of the coupler 10 is opened.

The cleaning process may comprise a three stage, flush, clean, rinse process, however it will be appreciated that any one or more of these processes may be carried out in isolation, and the order may be varied.

To flush the system the first inlet valve 120 is opened to connect the inlet conduit 112 to the water supply conduit 118, the first and second return valves 128, 132 are closed, and the third return valve 136 is opened. The pump 116 is then activated to pump water from the water supply conduit 118 through the coupler 10 of a first keg 106, out of the beverage port 34 thereof and to the beverage dispensing unit 110 via a first beverage line 146. The water passes out of the outlet 142 associated with the first keg, through the cleaning jumper 138 and into the outlet 140 associated with the second keg. The water then flows (in a reverse direction compared to a normal beverage dispensing operation) through the second beverage line 148 between the beverage dispensing unit 110 and into the beverage port 34 of the coupler 10 associated with the second keg 106. The water flows out of the cleaning fluid port 32, through the cleaning fluid return conduit 114 and the open third return valve 136, and exits the system to a drain 150. In this manner residual product in the system can be flushed therefrom.

Once flushed, the process can progress to the cleaning stage. In order to progress the first inlet valve 118 closes and the second inlet valve 124 opens. It will be appreciated that these changes may be done manually but in the example embodiment the valves are electrically operated valves and the change from flush cycle to cleaning cycle is conducted automatically by an electronic controller (omitted for clarity). The switch of the valves changes the connection of the pump 116 from the water supply conduit 118 to the cleaning fluid supply conduit 122. Simultaneously, or shortly thereafter, the third return valve 136 closes and the second return valve 132 opens. Operation of the pump now pumps cleaning fluid through the coupler of the first keg 106, through the beverage lines 146, 148 and the dispensing unit 110 and through the coupler 10 of the second keg 106 cleaning all internal beverage contact surfaces of the couplers 10 and the dispense system. The cleaning fluid recirculation line 130 is connected to the cleaning fluid supply conduit 122 such that the cleaning fluid can be recirculated through the system for a period of time. In the example embodiment the cleaning fluid recirculation line 130 may be connected to the cleaning fluid supply conduit 122 via a cleaning fluid tank 152 in which the cleaning fluid may be prepared by mixing a concentrated cleaning fluid with water from a fresh water supply 154, which is connected to the cleaning fluid tank 152 by means of a first water supply valve 156. In the example embodiment the cleaning fluid tank 152 is physically located higher than the pump 116 such that cleaning fluid may be fed to the pump 116 by gravity.

Once the cleaning fluid has circulated for a required period of time the second inlet valve 124 is closed and the first inlet valve is opened, to change the connection of the pump 116 from the cleaning fluid supply conduit 122 back to the water supply conduit 118. Simultaneously, or shortly thereafter, the second return valve 132 closes and the first return valve 128 opens. As mentioned above these changes are made automatically by an electronic controller.

Operation of the pump now pumps water through both couplers, rinsing all internal beverage contact surfaces thereof, and through the beverage lines 146, 148 and the dispensing unit 110 as described above. The rinse recirculation line 126 is connected to the water supply conduit 118 such that the water can be recirculated through the system for a period of time to thoroughly rinse it. Optionally the rinse recirculation line 126 may be connected to the water supply conduit 118 via a water tank 156 which may be filled from the fresh water supply 154, which is connected to water 152 by means of a second water supply valve 158. In the example embodiment the water tank 152 is physically located higher than the pump 116 such that water may be fed to the pump 116 by gravity. Locating the tanks 152, 156 higher than the pump 116 enables better pump efficiency as the pump 116 does not have to pull against a negative pressure head on its supply side.

Once rinsed the system is ready to be used for dispensing beverage again by placing the couplers 10 in the configuration shown in FIGS. 7 and 8, either by manual or automatic operation of the first and second valve members 36, 38.

Optionally, prior to using for dispensing, a second rinse cycle may be carried out. In order to carry out the second rinse cycle, water drain valve 160 is opened to allow the fluid in the water tank 156 to empty therefrom under gravity to the drain 150, after which the water tank 156 is refilled by opening the second water supply valve 158. The first inlet valve 120 and first return valve 128 may be closed whilst this is being done, or alternatively they could remain open and the pump 116 stopped or operated at a reduced speed. The wate tank may have a level sensor and the second water inlet valve 158 may be automatically activated and deactivated to maintain or achieve a water level in the water tank 156 at a predetermined level. Once the water tank has been emptied and refilled, or after sufficient changeover of water has occurred, the water drain valve 160 is closed and the rinse stage is repeated. As, during the first rinse phase, circulating water will entrain any residual cleaning fluid, the draining, refilling and second rinse phase will reduce any trace of cleaning fluid in the system prior to reconnecting the dispensing unit 110 to the kegs 106.

As shown, the cleaning fluid tank 152 also has an associated drain valve 162 via which, at the end of a cleaning cycle, the used cleaning fluid can be drained therefrom.

It is particularly advantageous that the coupler 10 can accept a flow between the beverage port 34 and the cleaning fluid port 32 in both directions, as this allows the cleaning systems to flow to and from the beverage dispensing unit 110 via the existing beverage lines 146, 148. Furthermore, although FIG. 9 shows an embodiment with two kegs, it will be appreciated that more kegs could be used. For example, in and embodiment with four kegs the cleaning fluid port 32 of the coupler of the first keg is connected to the cleaning fluid inlet conduit 112, the cleaning fluid port 32 of the coupler of the second keg is connected to the cleaning fluid port 32 of the coupler of the third keg, via a keg jumper conduit, and the cleaning fluid port 32 of the coupler of forth keg is connected to the cleaning fluid return conduit 114. In this arrangement a first cleaning jumper 138 is connected between the outlets of the beverage dispensing unit 110 associated with the first and second keg, and a second cleaning jumper 138 is connected between the outlets of the beverage dispensing unit 110 associated with the third and fourth keg. This daisy chaining of the couplers together is only enabled by the valve design permitting bidirectional cleaning flow.

Furthermore, although the system described in the example embodiment depicts the couplers 10 being connected to the kegs, as described herein above, as the couplers 10, when in the position shown in FIGS. 1 to 4, completely isolate the interior volume of the coupler even when disconnected from a keg, it will be appreciated that the couplers can still be cleaned as described herein when disconnected from a keg. As such, if one of the beverage lines 146, 148 is not currently in use, cleaning of the system is not prevented.

As depicted the system is split into two parts by the line “A”. It will be appreciated that the section to the right of line A shows the supply system for the cleaning and rinsing fluids and the part of the system to the left of line A shows the keg and dispense side of the system. It will be appreciated that for each set of interconnected couplers, one supply system will be needed. It will also be understood that the details of the supply system are not limited to those described herein and that the keg couplers may be used with any suitable supply system of cleaning fluids.

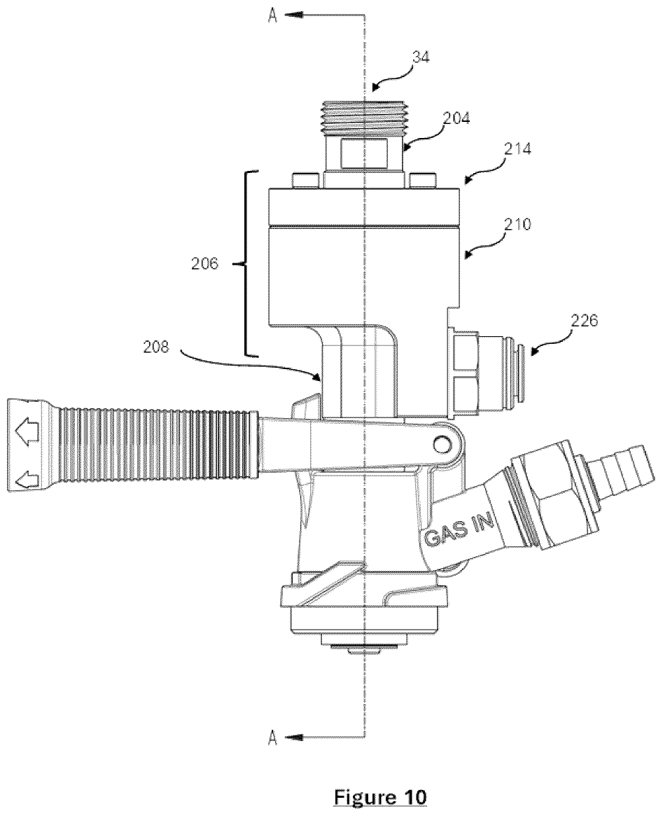

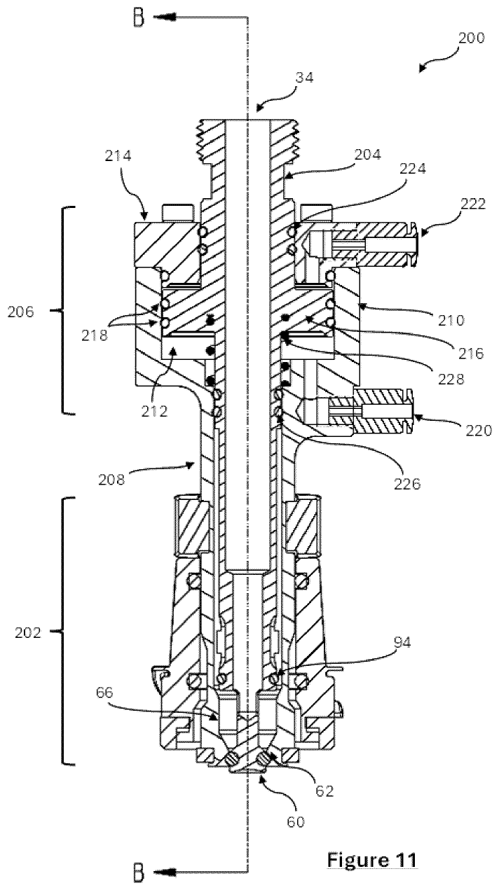

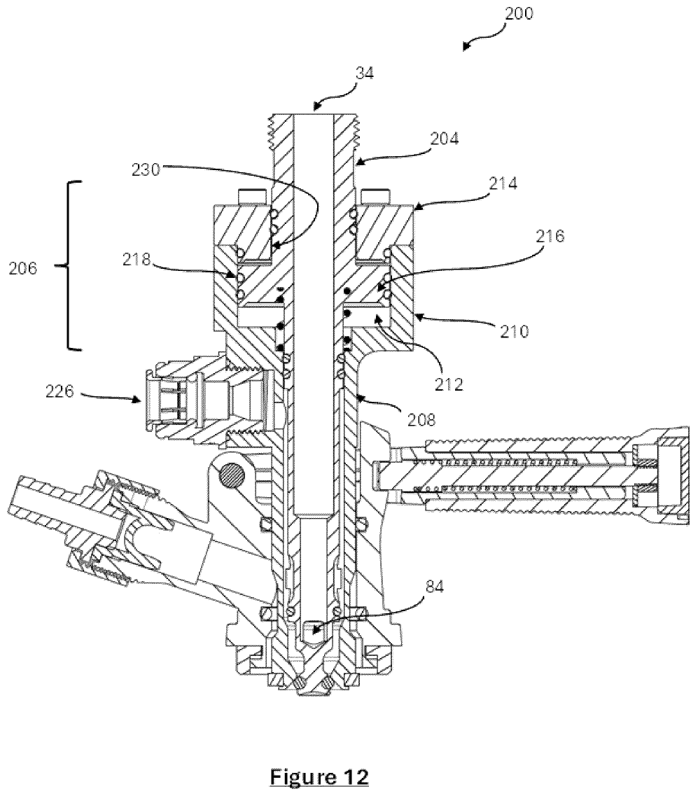

Referring to FIGS. 10 to 12 a coupler of a second embodiment 200 of the invention is shown. In this embodiment the lower part of the coupler 202 is substantially as shown in FIG. 6, however in this embodiment the second valve member 204 is automatically actuated by a fluid actuator 206 instead of the manually operated second actuator 70 of FIG. 6.

The first valve member 208 has an enlarged section 210 forming a piston chamber 212, which is enclosed at its upper end by a chamber cap 214, having an opening 230 therein. The second valve member 204 passes through the opening 230 and through the enlarged section 210 from where it continues to extend co-axially within the first valve member 208.

The second valve ember 208 has an enlarged diameter section 216 that forms a piston which engages with the inner walls of the piston chamber 212. Sealing means such as O-rings 218 or other slidable seals are located on the enlarged diameter section 216 of the second valve member 204 such that it can move coaxially within the first valve member 210 in the enlarged section 210. A first actuator fluid port 220 passes through the first valve member 210 and opens into the piston chamber 212 on a first side of the enlarged diameter section 216 of the second valve member 204 and a second actuator fluid port 222 passes through the chamber cap 214 and opens into the piston chamber 212 on a second side of the enlarged diameter section 216 of the second valve member 204, although it will be appreciated that the second actuator fluid port could alternatively pass through the first valve member to open into the second side of the enlarged diameter section 216 of the second valve member 204.

Siding seals 224, 226, for example O-rings, are provided between the second valve member 204 and the first valve member 210, and between the second valve member 204 and the chamber cap 214. In this manner a double acting piston actuator is formed between the first valve member 210 and the second valve member 204.

Application of actuation fluid, for example a compressed gas, to the first actuator fluid port 220 will flow into the piston chamber 212 and act on the enlarged diameter section 216 of the second valve member 204 to cause the second valve member 204 to move into the cleaning position in which the valve plug 60 seals against the valve seat 62 to prevent flow of product through the coupler 200. In this position cleaning fluid can circulate into the cleaning fluid port 226, flow between the first valve member 208 and the second valve member 204, pass into the lower end of the second valve member via the openings 84 therein, travel up the centre of the second valve member and exit via the beverage port 34. It will be appreciated that the cleaning fluid is also able to flow in the reverse direction via the same flow-path.

Application of actuation fluid, for example a compressed gas, to the second actuator fluid port 222 will flow into the piston chamber 212 and act on the enlarged diameter section 216 of the second valve member 204 to cause the second valve member 204 to move into the dispensing position in which the valve plug 60 seals moves away from the valve seat 62 to allow flow of product through the coupler and prevent egress of cleaning fluid. As described hereinabove, this movement causes the O-ring 94 to move with the second valve member 204 such that it enters short section of the bore 66 of the first valve member 208 having the decreased diameter. The O-ring 94 is sized such that the outer diameter thereof forms a seal with the section of the bore 66 having the decreased diameter thereby preventing cleaning fluid from passing the O-ring 94.

It will be appreciated that any suitable actuation fluid may be used to move the enlarged diameter section 216 of the second valve member 204 within the piston chamber 212 of the first valve member 208. In one embodiment a pressurised flow of the cleaning fluid may be used to move the second valve member, in another example a pressurised supply of carbon dioxide or nitrogen, which are commonly used in beverage dispense systems, or any other suitable gas, may be used.

A spring 228 is provided within the piston chamber 212 and acts between the first valve member 208 and the second valve member 204 to bias the second valve member 204 into the cleaning position. In this manner, in the event of a failure in the supply of the actuation fluid to the coupler 200, the second valve member 204 will move, under the bias of the spring 228 into a position in which the flow path of product fluid from a keg, to which it is attached, to the beverage port 34 is closed. In addition, in the even that the coupler 200 is dethatched from a keg at the time of a failure in the actuation fluid, the coupler will be spring biased towards a position in which the coupler is sealed at its connection end.

It will be appreciated that various changes and modifications can be made to the present invention without departing from the scope of the present application.

1. A coupler for a beverage keg the coupler comprising:
a coupler body;
a first inlet for connection to a beverage keg via a coupling means;
a second inlet for receiving a supply of compressed gas;
a gas outlet adjacent the first inlet;
a cleaning fluid port for fluid connection with a flow of cleaning fluid;
a beverage port for fluid connection with a beverage dispenser; and
valve means, wherein the valve means comprises:
a first valve member axially movable within the coupler body between a first position in which a fluid flowpath between the second inlet and the gas outlet is closed and a second position in which a fluid flowpath between the second inlet and the gas outlet is open; and wherein,
a second valve member axially movable within the first valve member between a cleaning position in which a fluid flowpath between the cleaning fluid port and the beverage port is open and a flowpath between the first inlet and the beverage port is closed, and a dispensing position in which the fluid flowpath between the cleaning fluid port and the beverage port is closed and the flowpath between the first inlet and the beverage port is open.

2. The coupler of claim 1 wherein the second valve member has a valve plug at a distil end thereof, the valve plug sealing against a valve seat disposed on the first valve member when the second valve member is in the first position and spaced away from the valve seat when the second valve member is in the second position.

3. The coupler of claim 2 further comprising a cleaning chamber created between the first valve member, the second valve member and the valve plug when the second valve member is in the cleaning position.

4. The coupler of claim 2 further comprising a cleaning fluid flow passage extending axially along the keg coupler from the cleaning fluid inlet between the first valve member and the second valve member.

5. The coupler of claim 4 wherein the cleaning fluid flow passage extends between the cleaning fluid inlet and the cleaning chamber.

6. The coupler of claim 5 wherein a cleaning valve is formed between the exterior of the second valve member and the interior of the first valve member, said cleaning valve actuated by relative movement of the second valve member within the first valve member, said valve operable to selectively open and close the cleaning fluid flow passage.

7. The coupler of claim 6 wherein when the second valve member is in the cleaning position the cleaning valve is open to permit cleaning fluid flow between the cleaning fluid inlet and the cleaning chamber.

8. The coupler of claim 6 wherein when the second valve member is in the dispensing position the cleaning valve is closed to prevent cleaning fluid flow between the cleaning fluid inlet and the cleaning chamber.

9. The coupler of claim 6 wherein the second valve member comprises a substantially hollow member having the beverage port at one end and the valve plug at the other end.

10. The coupler of claim 9 wherein the second valve member comprises an internal flowpath between a second valve member opening adjacent the valve plug and the beverage port.

11. The coupler of claim 10 wherein the second valve member opening is located between the valve plug and the cleaning valve such that, when the second valve member is in the cleaning position the second valve member opening is located on the cleaning chamber.

12. The coupler of claim 1 wherein a section of the second valve member is located concentrically within the first valve member.

13. The coupler of claim 1 wherein the first valve member is movable by a first actuator coupled to, or integral to, the connector body and the second valve member is movable by a second actuator coupled to, or integral to the first valve member.

14. The coupler of claim 13 wherein the first actuator comprises a latch mechanism for latching the first valve member in the first position or the second position.

15. The coupler of claim 13 wherein the second actuator comprises a latch mechanism for latching the second valve member in the cleaning position or the dispensing position.

16. The coupler of claim 13 wherein the first actuator and/or the second actuator is manually operable.

17. The coupler of claim 13 wherein the first actuator and/or the second is automatically operable.

18. The coupler of claim 17 wherein the second actuator comprises a fluid operated cylinder formed between the first valve member and the second member.

19. The coupler of claim 18 wherein the second actuator comprises a piston movable within the cylinder and wherein a cylinder body is be formed in the first valve member and the piston is provided on the second valve member such that application of fluid pressure to one side of the piston or the other causes the second valve member to move between the cleaning position and the dispensing.
